(19) United States
(12) Patent Application Publication
(10) Pub. No.: US 2009/0160810 A1
(43) Pub. Date: Jun. 25, 2009

(54) PORTABLE ELECTRONIC DEVICE

(76) Inventors: Yi-Ching Liu, Taoyuan County (TW); Chih-Wei Tai, Taoyuan County (TW)

Correspondence Address: BIRCH STEWART KOLASCH & BIRCH, PO BOX 747, FALLS CHURCH, VA, 22040-0747, US

(21) Appl. No.: 12/336,902

(22) Filed: Dec. 17, 2008

(30) Foreign Application Priority Data
Dec. 19, 2007 (TW) 96148593

(51) Int. Cl. G06F 3/041

(52) U.S. Cl. 345/173

(57) ABSTRACT

A portable electronic device is provided and includes a first casing, a touch input unit, a switch, and a movable member. The touch input unit and the switch are disposed in the first casing, wherein the touch input unit is exposed to a first surface of the portable electronic device. The movable member is disposed on a second surface of the portable electronic device and is movable relative to the first casing, wherein the second surface is opposite to the first surface. The movable member is coupled with the touch input unit and the switch. Specifically, the movable member activates the switch when pressed.

### CROSS REFERENCE TO RELATED APPLICATIONS

This Application claims priority of Taiwan Patent Application No. 96148593, filed on Dec. 19, 2007, the entirety of which is incorporated by reference herein.

### TECHNICAL FIELD

The application relates in general to a portable electronic device and in particular to a portable electronic device capable of haptic feedback.

### DESCRIPTION OF THE RELATED ART

Traditional mobile phones usually have a dialing keypad on a main surface thereof. When any key of the dialing keypad is pressed, a flexible metal dome corresponding to the key deforms and provides a click feeling to the user as input confirmation for a successful pressed key.

However, since the dialing keypad has many protruding key lids with obvious slits formed therebetween, it is difficult for designers to achieve design of a mobile phone with an integral and smooth profile. Conventional dialing keypads may be replaced by touch pads which have a smooth profile, but the touch pad does not provide a click feeling or haptic feedback to users.

### BRIEF SUMMARY

The present application provides a portable electronic device including a first casing, a touch input unit, a switch, and a movable member. The touch input unit and the switch are disposed in the first casing, wherein the touch input unit is exposed to a first surface of the portable electronic device. The movable member is disposed on a second surface of the portable electronic device and is movable relative to the first casing, wherein the second surface is opposite to the first surface. The movable member is coupled with the touch input unit and the switch. Specifically, the movable member activates the switch when pressed.

### BRIEF DESCRIPTION OF DRAWINGS

The application can be more fully understood by reading the subsequent detailed description and examples with references made to the accompanying drawings, wherein:

FIG. 1 is a perspective diagram of a portable electronic device according to an embodiment of the invention;

FIG. 2 is a sectional view along X1-X2 of FIG. 1;

FIG. 3 is a perspective diagram of a movable member when pressed;

FIG. 4 is a perspective diagram of a portable electronic device according to another embodiment of the invention;

FIG. 5 is a perspective diagram of a portable electronic device according to another embodiment of the invention; and

FIG. 6 is a perspective diagram of a portable electronic device according to another embodiment of the invention.

### DETAILED DESCRIPTION

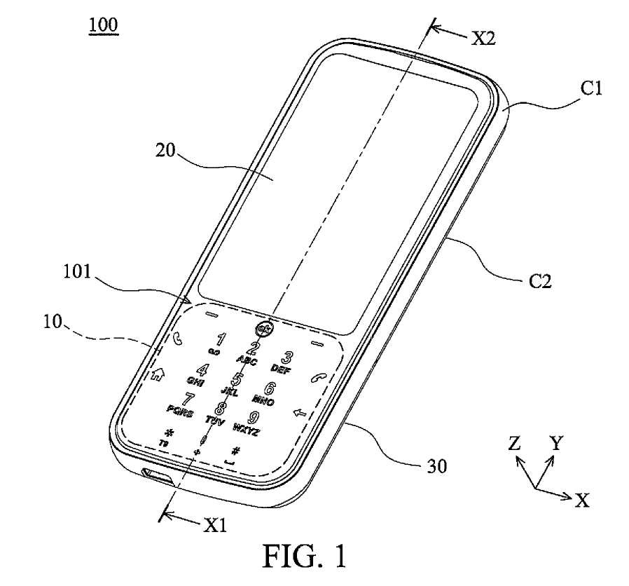

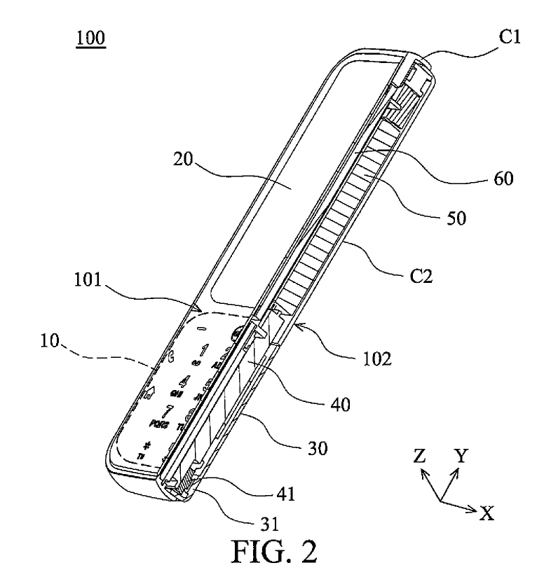

Referring to FIGS. 1 and 2, an embodiment of a portable electronic device 100 (such as a PDA) comprises a first casing C1, a second casing C2, a touch input unit 10, a display 20, a movable member 30, a circuit module 40, a battery 50, and a display module 60. The touch input unit 10 may be a resistive or capacitive touch keypad substantially parallel to an XY plane including a plurality of dialing keys. In this embodiment, the touch input unit 10 and the display 20 are received in the first casing C1, and both of them are exposed to a first surface 101 of the portable electronic device 100. The first surface 101 can be a smooth surface to facilitate an integral and smooth front profile of the portable electronic device 100.

As shown in FIGS. 1 and 2, the movable member 30 and the casing C2 are disposed on a second surface 102 of the portable electronic device 100, opposite to the first surface 101. The movable member 30 is located adjacent to the casing C2 and movable with respect to the first casing C1. In FIG. 2, the circuit module 40 is disposed between the touch input unit 10 and the movable member 30, and the display module 60 is disposed between the display 20 and the battery 50. The circuit module 40 electrically connects to the touch input unit 10 and the display module 60, and the display module 60 electrically connects to the display 20. Users can control the cursor or input data though the touch input unit 10, such as dialing numbers or inputting characters by either typing or handwriting. The circuit module 40 can transmit electronic signals to the display module 60, such that the display 20 shows corresponding contents according to the input from the user.

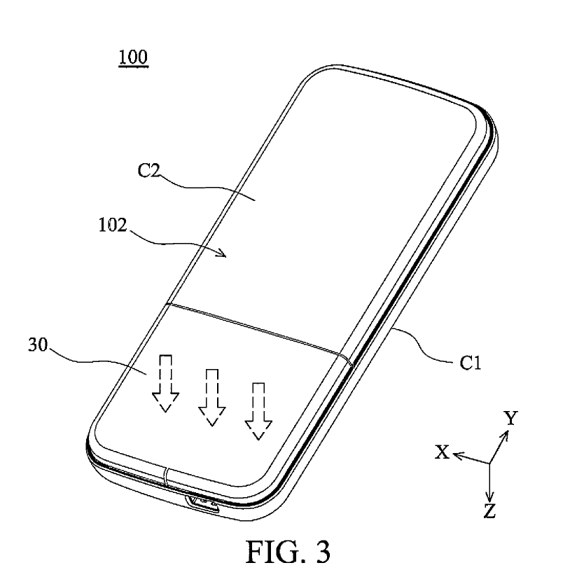

Referring to FIGS. 1˜3, when the user holds the portable electronic device 100 with intention to input a data, his thumb can move to any desired position on the touch input unit 10 for data input (upon any number or symbol key shown in FIG. 1), and the other four fingers can push the movable member 30 from the second surface 102, as the arrows indicate in FIG. 3. When the movable member 30 is pressed, a contact portion 31 thereof advances along a first direction (Z axis) and activates a switch 41 on the circuit module 40 (FIG. 2). In some embodiments, the switch 41 may be a mechanical switch or tactile switch capable of providing haptic feedback to the user. When the switch 41 is activated, an active signal is transmitted from the switch 41 to the circuit module 40 for input confirmation, to make sure an input action is completed. On the contrary, if the switch 41 is not activated, any input action on the touch input unit 10 would be invalid, so as to prevent undesired inputting and distinguish between unintentional and intentional touches.

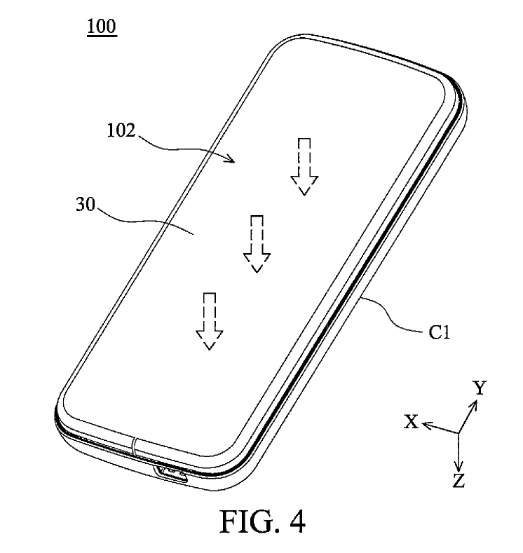

Referring to FIG. 4, another embodiment of the movable member 30 is disposed on the second surface 102 of the portable electronic device 100 and movable relative to the first casing C1 along Z axis, as the arrows indicate in FIG. 4. In this embodiment, the movable member 30 replaces the second casing C2 in FIG. 2 and conceals both of the circuit module 40 and the display module 60. As the movable member 30 has large dimensions, convenience of usage and haptic feedback are improved.

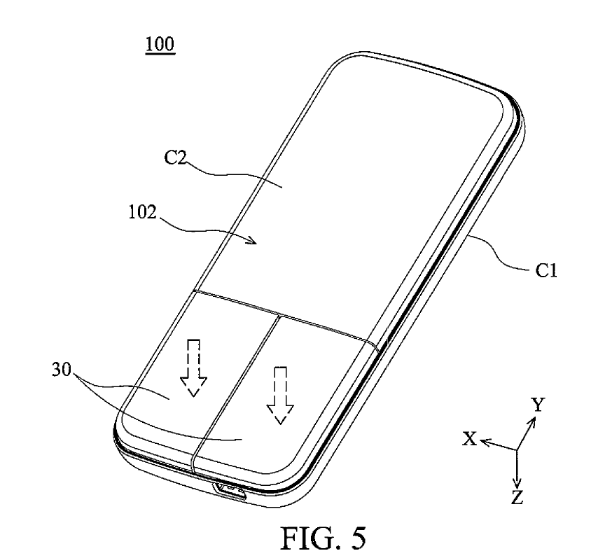

Referring to FIG. 5, another embodiment of the portable electronic device 100 comprises two movable members 30 disposed on the second surface 102. The two movable members 30 are arranged adjacent to the second casing C2 and movable relative to the first casing C1 along Z axis, as the arrows indicate in FIG. 5. In this embodiment, the location of the two movable members 30 correspond to the touch input unit 10 on the first surface 101, thus facilitating haptic feedback and convenient usage for users. When the movable members 30 are pressed, one or more switches on the circuit module 40 are respectively activated for input confirmation, so as to prevent undesired inputting and distinguish between unintentional and intentional touches.

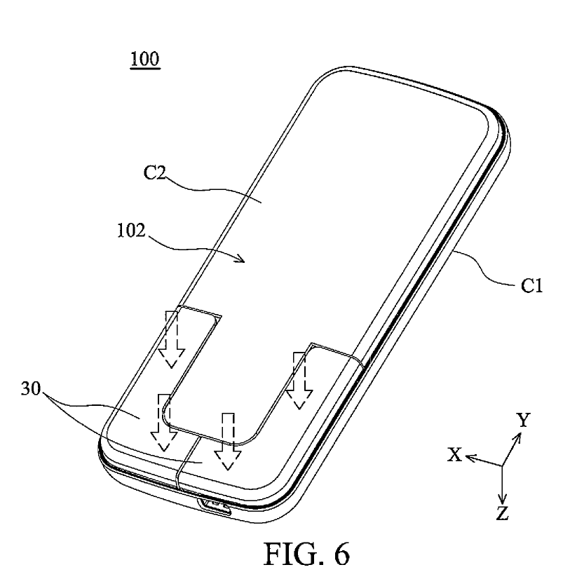

Referring to FIG. 6, another embodiment of the portable electronic device 100 comprises two movable members 30 disposed on the second surface 102. The two movable members 30 are L-shaped and movable relative to the first casing C1 along Z axis, as the arrows indicate in FIG. 6. Location of the two movable members 30 correspond to the touch input unit 10 on the first surface 101, thus facilitating haptic feedback and convenient operation for users. When the movable members 30 are pressed, one or more switches on the circuit module 40 are respectively activated for input confirmation.

The application provides a portable electronic device 100 comprising at least a movable member 30 capable of providing haptic feedback and input confirmation. The user can touch the touch input unit 10 for data input from the first surface 101 with his thumb, and the other fingers can push the movable member 30 from the second surface 102. When the movable member 30 is pressed, the switch 41 is activated for input confirmation, and the movable member 30 provides haptic feedback to the user. Hence, the application can not only prevent undesired input, but also provide an integral and smooth front profile of the portable electronic device 100.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A portable electronic device, comprising:
a first casing;
a touch input unit, disposed in the first casing and exposed to a first surface of the portable electronic device for receiving input from a user;
at least a switch disposed in the first casing; and
at least a movable member disposed on a second surface of the portable electronic device and movable relative to the first casing along a first direction, wherein the second surface is opposite to the first surface, and the movable member is coupled with the touch input unit and the switch, wherein when the user handholds the portable electronic device and touches the input touch unit and applies a force to the movable member, the movable member activates the switch.

2. The portable electronic device as claimed in claim 1, further comprising a display disposed in the first casing and exposed to the first surface of the portable electronic device, wherein the first surface is a smooth surface with the display and the touch input unit exposed thereto.

3. The portable electronic device as claimed in claim 1, further comprising a second casing disposed on the second surface and adjacent to the movable member.

4. The portable electronic device as claimed in claim 1, wherein the touch input unit comprises a resistive or capacitive touch keypad.

5. The portable electronic device as claimed in claim 1, wherein the first direction is substantially perpendicular to the first surface.

6. The portable electronic device as claimed in claim 1, further comprising a circuit module electrically connected to the touch input unit and the switch, wherein when the movable member activates the switch, the switch transmits an active signal to the circuit module.

7. The portable electronic device as claimed in claim 6, further comprising a display module and a display, wherein the display module electrically connects to the display and the circuit module, wherein when the circuit module receives the active signal from the switch, the display shows a corresponding content according to the input from the user.

8. The portable electronic device as claimed in claim 7, wherein the movable member movably connects to the first casing and conceals the circuit module and at least a part of the display module.

9. The portable electronic device as claimed in claim 1, further comprising a plurality of movable members disposed on the second surface and movably connected to the first casing.

10. The portable electronic device as claimed in claim 9, wherein the movable members are L-shaped.

11. The portable electronic device as claimed in claim 9, further comprising a plurality of switches corresponding to the movable members, wherein the movable members respectively activate the switches when pressed.

12. The portable electronic device as claimed in claim 1, wherein the switch is a mechanical switch.

13. The portable electronic device as claimed in claim 11, wherein the switches are mechanical switches.
